(19) United States
(12) Patent Application Publication
(10) Pub. No.: US 2015/0319221 A1
(43) Pub. Date: Nov. 5, 2015

(54) TRACING BUSINESS TRANSACTIONS BASED ON APPLICATION FRAMEWORKS

(71) Applicant: AppDynamics, Inc., San Francisco, CA (US)

(72) Inventors: Andrei Zmievski, San Francisco, CA (US); Rama Krishna Tummala, Fremont, CA (US)

(73) Assignee: AppDynamics, Inc., San Francisco, CA (US)

(21) Appl. No.: 14/266,654

(22) Filed: Apr. 30, 2014

(51) Int. Cl. H04L 29/08; G06Q 10/06

(52) U.S. Cl. CPC H04L 67/10; G06Q 10/067

(57) ABSTRACT

A distributed transaction is traced to determine how it is handled by applications which process the distributed transaction at least in part without threads. To trace the transaction, the business transaction may be named based on the application framework that handles the transaction. The tracing occurs in application frameworks which do not include multiple threads for handling transactions, such as for example a PHP application framework. The present technology may detect the framework and framework calls, and then generate a name for a business transaction based on the detected information. The business transaction may then be named based on the loaded application framework.

### BACKGROUND

The World Wide Web has expanded to provide web services to large numbers of consumers. Web services may be provided by a web application which uses one or more services to handle a transaction. The applications may be distributed over several machines.

Monitoring a web application helps to provide insight regarding bottle necks in communication, communication failures and other information regarding performance of the services that provide the web application. For distributed applications which are handled by several machines, it is important to provide as much detail as possible regarding how those machines handle the distributed application.

Java applications processed over multiple servers may be traced at each machine. Each application may be named, handled by a thread, and otherwise monitored to determine what happens within the distributed transaction. Other types of application frameworks do not have separate threads for handling calls as a Java application framework does. There is a need in the art for a way to monitor distributed transactions in that cannot be traced based on threads.

### SUMMARY

The present technology, roughly described, traces how a distributed transaction is handled by applications, wherein at least part of the processing may be performed by an application module that may not utilize threads. The business transaction can be named based on the application framework that handles the transaction. The tracing occurs in application frameworks which do not include multiple threads for handling transactions, such as for example a PHP hypertext preprocessor (PHP) application framework.

The present technology may detect the framework and framework calls and generate a name for a business transaction based on the detected information. For example, the loading of an application framework may be detected. The business transaction may then be named based on the loaded application framework. When the framework makes a call, the business transaction name, type and other data may be loaded onto a payload of the call and transmit the payload. In some instances, if a call occurs before a framework is loaded, parameters such as a business transaction type may be set to a default value such as “web”. Similarly, a parameter such as a business transaction name may be set to a default value such as “URL”. In other instances, if a call occurs after a framework is loaded but before the business transaction is named, the business transaction name and type may not be added to an outgoing request. It is determined that the business transaction name and type will be detected later in the business transaction progressing.

In an embodiment, a method for tracing a distributed transaction may detect a PHP application framework call to a remote server. The call may be part of a distributed transaction that occurs over multiple servers including at least one PHP application. A business transaction name associated with the call may then be set. A PHP framework call may be modified with the business transaction name. The modified PHP framework call may then be transmitted to the remote server.

A system for tracing a distributed transaction may include a processor, memory and one or more modules stored in the memory. The one or more modules may be executable by the processor to detect a PHP application framework call to a remote server, wherein the call part of a distributed transaction that occurs over multiple servers including at least one PHP application, set a business transaction name associated with the call, modify PHP framework call with the business transaction name, and transmit the modified PHP framework call to the remote server.

### BRIEF DESCRIPTION OF THE DRAWINGS

FIG. 1 is a block diagram of a system for tracing distributed PHP applications.

FIG. 2 is a block diagram of an application server within a PHP application.

FIG. 3 is a method for tracing a PHP application.

FIG. 4 is a method for processing a call in a PHP application before an application framework is loaded.

FIG. 5 is a method for processing a call before a business transaction name is completely generated.

FIG. 6 is a block diagram of a computing system for implementing the present technology.

### DETAILED DESCRIPTION

A distributed transaction may be traced to determine how it is handled by applications which process the distributed transaction, wherein at least part of the processing may be performed by an application module that may not utilize threads. To trace the transaction, the business transaction may be named based on the application framework that handles the transaction. The tracing occurs in application frameworks which do not include multiple threads for handling transactions, such as for example a PHP hypertext preprocessor (PHP) application framework.

The present technology may detect the framework and framework calls and generate a name for a business transaction based on the detected information. For example, the loading of an application framework may be detected. The business transaction may then be named based on the loaded application framework. When the call is processed by the framework, the business transaction name, type and other data may be loaded onto a payload of the call and transmit the payload. In some instances, if a call occurs before a framework is loaded, parameters such as a business transaction type may be set to a default value such as “web”. Similarly, a parameter such as a business transaction name may be set to a default value such as “URL”. In other instances, if a call occurs after a framework is loaded but before the business transaction is named, the business transaction name and type may not be added to an outgoing request. It is determined that the business transaction name and type will be detected later in the business transaction progressing.

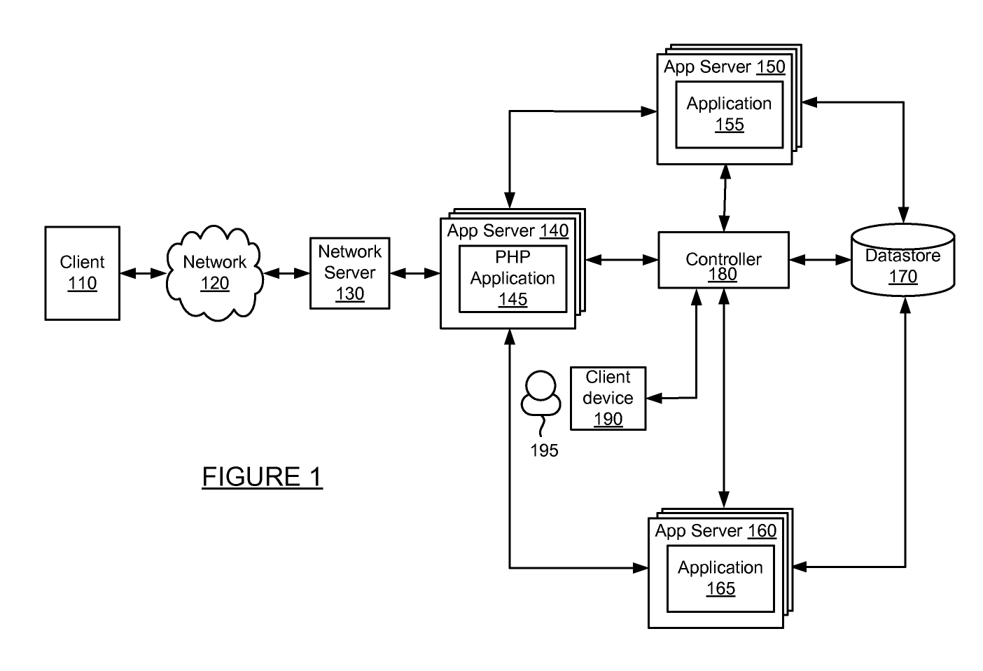

FIG. 1 is a block diagram of a system for tracing distributed PHP applications. The system of FIG. 1 includes client 110, network server 130, application servers 140, 150 and 160, data store 170, controller 180 and client device 190. Client 110 may communicate with network server 130 and/or application servers 140-160 over network 120. Client 110 may be any device capable of communicating over a network, such as for example, a desktop computer, a workstation, a tablet computer, a mobile device such as a smart phone, or other computing device.

Network 120 may include one or more networks for communicating data between two machines, such as for example, client 110 and network server 130. Network 120 may include a private network, public network, intranet, the Internet, a cellular network, or some combination of these networks.

Network server 130 may include one or more machines that receive requests over network 120 and provide the request to application server 140. A response generated by an application server to requests received over network 120 may be provided to the requesting machine by network server 130. In some embodiments, application server 140 and network server 130 may be implemented on the same machine of different machines.

Application server 140 may include one or more machines that include applications or portions of applications for processing requests received over network 120. In some embodiments, an application server 140 may include an application based on a scripting language, such as for example PHP application 145. The PHP application may process requests, send calls to other application servers and applications, such as application 155 and application 165 on application servers 150 and 160, respectively.

The system and techniques discussed herein reference a PHP application, such as PHP application 145, for purposes of example only. It should be understood that the present system and techniques described herein may apply to any application in which the loading of the application framework may be detected.

Application server 150 may include application 155, which may be implemented as a Java or a .NET type application framework. Application 165 on application server 160 may also be implemented as a Java or .NET application framework. Each of application servers 150 and 160 may receive and process requests from application server 140 as well as each other. Data store 170 may be accessed by any of application servers 140-160, and may store data. Controller 180 may communicate with application servers 140-160 as well as data store 170. In some embodiments, controller 180 may receive data from one or more programs executing on machines 140-170. A user may access process data received and processed by controller 180 via client device 190.

The elements of FIG. 1 are described in more detail in U.S. patent application Ser. No. 1287,919, filed Sep. 9, 2010, entitled “Monitoring Distributed Web Application Transactions,” and U.S. patent application Ser. No. 14/018,346, filed Sep. 8, 2013, entitled “Business Transaction Correlation with Client Request Monitoring Data”, the disclosures of which are incorporated herein by reference.

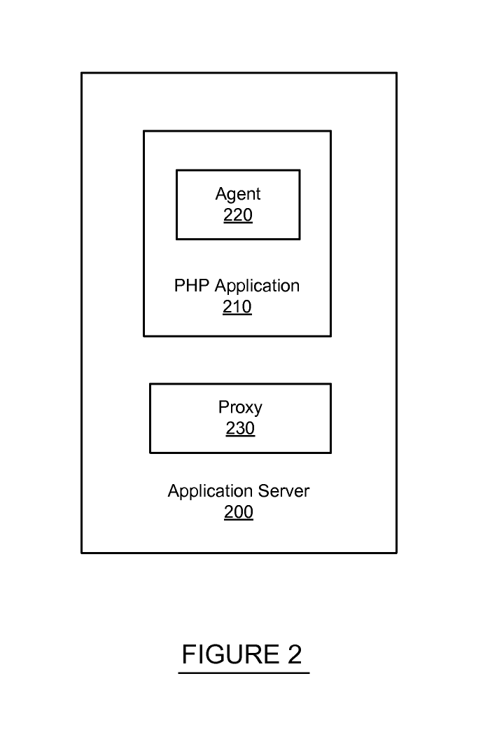

FIG. 2 is a block diagram of an application server which hosts a PHP application. In some embodiments, application server 200 of FIG. 2 may provide more detail for application server 140 in the system of FIG. 1. Application server 200 may include PHP application 210 and proxy 230.

PHP application 210 may include an agent 220. The agent may detect when an application framework loads and executes, for example via one or more intercepted calls which are communicated to agent 220. Agent 220 may send framework loading detection information and other data to proxy 230, such a call graph, error information for one or more process calls, snapshot data, and other data. A call graph may specify a sequence of machines or applications that have processed the distributed transaction. The error information may indicate errors detected in the processing of a request, a framework loading, or other errors related to the business transaction. Snap shot data may include detailed data for the processing of a business transaction by the PHP application.

Agent 220 may modify the header of an outgoing call made by an application framework of application server 200 with the snapshot data when instructed to do so by a proxy.

Proxy 230 may receive and aggregate metrics collected by one or more agents such as agent 220. The system for processing a distributed transaction may include multiple application servers, each with a PHP application and an agent. Each agent may communicate and provide information to proxy 230, and proxy 230 may instruct each agent on the one or more application servers.

Proxy 230 may collect a “snapshot” of data provided by one or more agents and send the snapshot data to the next tier which processes the distributed business transaction. In some embodiments, the snapshot and other data is loaded onto a payload of a request being sent if needed, such as for example to collect information when an application, method or other code or hardware is not performing as desired. The proxy may determine if a snapshot should be collected through internal computations and comparisons. For example, a snapshot may be collected based on a name match of one or more names stored and accessible by the proxy, execution duration of a current request or transaction, or upon user request at a control panel.

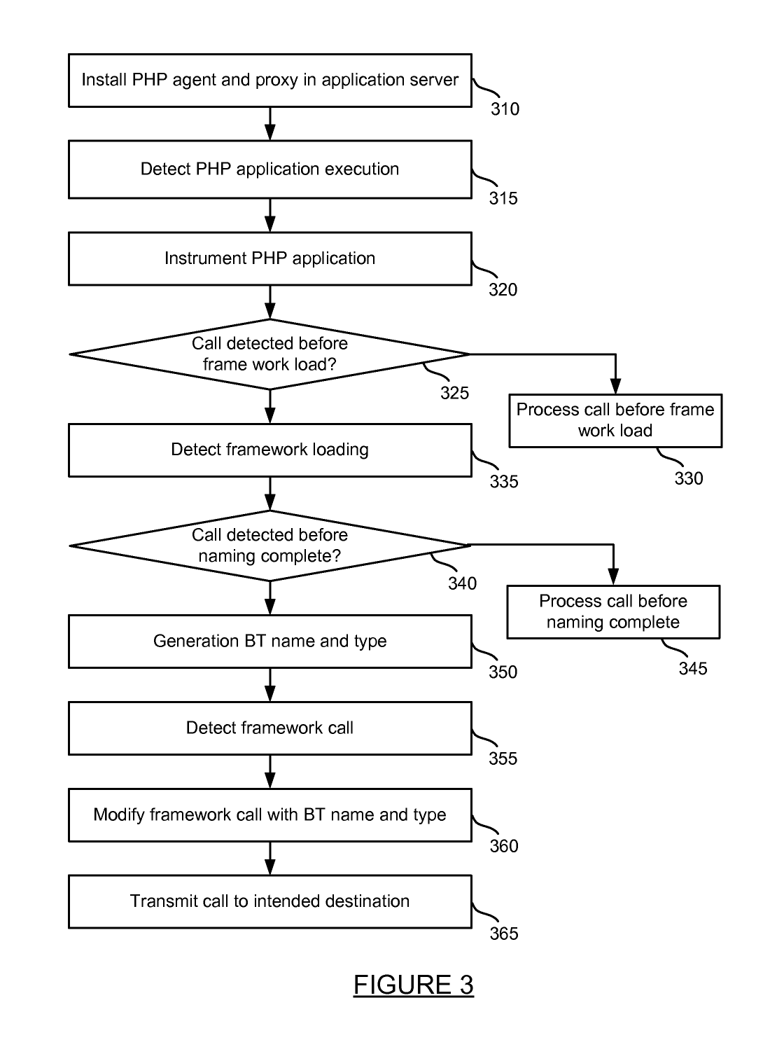

FIG. 3 is a method for tracing a PHP application. First, a PHP agent and a proxy may be installed in an application server at step 310. The agent and proxy may be installed into a PHP application by downloading the agent and proxy or by some other method. After being installed, execution of a PHP application may be detected at step 315. The application may be called by another device and/or service, for example, as part of a call to the PHP application. Once application execution is detected, the PHP application may be instrumented at step 320. Instrumenting the PHP application may be performed place code at exit points and other desired portions of one or more applications to subsequently detect exit calls to other applications, services, data stores and databases, and other machines.

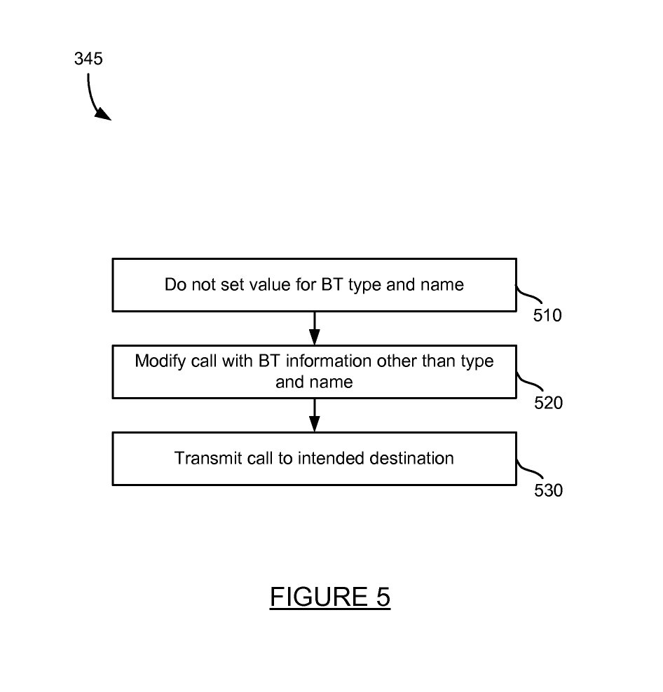

A determination is made as to whether a call is detected before the framework is loaded at step 325. The call may include an outgoing call (e.g., an external call or exit call) to another application server. If a call is detected before the application framework is loaded, the call is processed before the framework loads at step 330. Since a business transaction in a PHP application may be named based on the framework, naming the business transaction before the framework loads may differ from when the call is detected after the application framework loads. For instance, when the application framework information is not available, default information may be used to name the business transaction name and type to be packaged with the payload in the call. Processing a call before a framework loads is discussed in more detail below with respect to the method of FIG. 5.

If a call is not detected before a framework loads, the application of framework loading is detected at step 335. The framework loads in response to application execution detected at step 315. There may be many types of PHP application frameworks for which loading may be detected. The present system may be configured to detect the loading of multiple application framework types, for example Laravel, CodeIgnite, CakePHP, Syfony, Zend, Phalcon, Yii, Aura, Seagull, and FuelPHP frameworks. After detecting the framework loading, a determination is made as to whether a call is detected before the naming of the business transaction is complete at step 340. The framework loading may have started even though the naming of the call is not complete. If the call is detected before the naming is complete, the call is processed before the naming is completed at step 345. More information regarding how a call is processed before naming is complete is discussed below with respect to the method of FIG. 5.

If a call is not detected before the naming is complete, a business transaction name and type are generated at step 350. The name and type may be derived from the loaded application framework. For example, a determination may be made as to the class of controller that should process the framework and for what actions the controller should be invoked. The business transaction name may be a combination of the controller and the transaction. The type of business transaction may be associated with the class of PHP framework controller. The business transaction name and type may be generated by a proxy after an agent informs the proxy of the application framework loading and information about the framework (e.g., controller information). For example, an agent may provide the proxy with the business transaction type and name, which the proxy may use to generate the business transaction name and type. After the business transaction name and type are generated, a framework call may be detected at step 355. The framework call is detected and received as part of an application execution. The framework call may be modified with the generated business transaction name and type at step 360. The name and type may be used together with snapshot data and call chain data to monitor the business transaction. The call is then transmitted to the intended destination with the modified framework call at step 365.

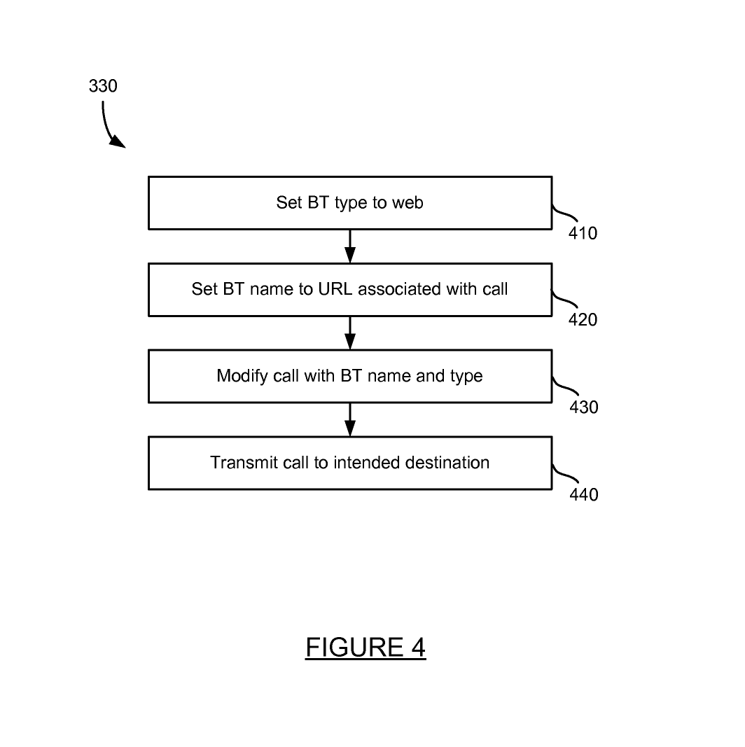

FIG. 4 is a method for processing a call in a PHP application before an application framework is loaded. The method of FIG. 4 provides more detail for step 330 of the method of FIG. 3. First, a business transaction type is set to “web” at step 410. This may be performed as a default value for the application type. In embodiments, other default values may be used for the application type as well. The business transaction name may be set to the uniform resource locater address associated with the call at step 420. Similar to the business transaction type, this particular business transaction name may merely be a default name. Other names may be used for a business transaction default name.

The outgoing call may be modified with the generated business transaction name and type at step 430. The business transaction type of “web” and business transaction name of the URL associated with the destination of the call is used to modify the call in place of step 360 of the method of FIG. 3. The call is then transmitted to the intended destination at step 440.

FIG. 5 is a method for processing a call before a business transaction name is completely generated. The method of FIG. 5 may provide more detail for step 345 of the method of FIG. 3. The present system does not set a value for the business transaction type and name at step 510. The business transaction type and name are not generated because the business transaction name and type will likely, if not definitely, be determined and added to the business transaction data later in the process of handling the business transaction. The controller will associate the business transaction name with the data collected from each application involved in the business transaction. The outgoing call may be modified with business transaction information other than the type and the name at step 520. This other information may include a snapshot, call chain, and other data. In some embodiments, the correlation header is modified in the outgoing call with the snapshot, call chain, and other data. Once the call is modified, the modified call is transmitted to its intended destination at step 530.

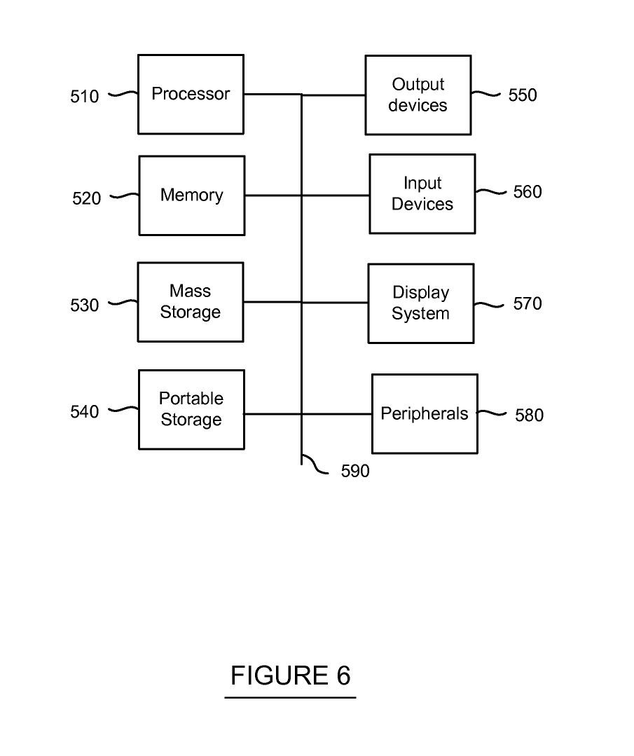

FIG. 6 is a block diagram of an exemplary computing system for implementing the present technology. System 600 of FIG. 6 may be implemented in the contexts of the likes of client computer 110, servers 120, 140, 150, and 160, data store 170 controller 180 and client device 190. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. As such, the computer system 600 of FIG. 6 may include additional components, such as an LED touch screen, one or more antennas, radios, and other circuitry and software for wireless communication, microphones, speakers, and other components. The computer can also include different bus configurations, networked platforms, multi-processor platforms, etc. Various operating systems can be used including Unix, Linux, Windows, Macintosh OS, Android, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for tracing a distributed transaction, comprising:
detecting a PHP application framework call to a remote server, the call part of a distributed transaction that occurs over multiple servers including at least one PHP application;
setting a business transaction name associated with the call;
modifying PHP framework call with the business transaction name; and
transmitting the modified PHP framework call to the remote server.

2. The method of claim 1, further comprising:
detecting framework loading;
setting a business transaction name based on the loaded framework; and
setting a business transaction type based on the loaded framework.

3. The method of claim 1, wherein the PHP framework call is detected before a framework is loaded, the method further comprising:
setting business transaction name based on an network address associated with the call; and
setting a business transaction type to a default value.

4. The method of claim 1, further comprising modifying the PHP framework call to include a unique request identifier.

5. The method of claim 1, further comprising:
retrieving call data by an agent; and
transmitting the call data by the agent.

6. The method of claim 1, further comprising transmitting a business transaction type, the business transaction name, and a call chain including a sequence of calls for the business transaction to a controller.

7. The method of claim 6, wherein the remote server receives the modified PHP framework call and reports processing of the call to the controller.

8. The method of claim 7, wherein the remote server includes a JAVA application which

9. The method of claim 7, wherein the remote server includes a .NET application.

10. A non-transitory computer readable storage medium having embodied thereon a program, the program being executable by a processor to perform a method for tracing a distributed transaction, the method comprising, comprising:
detecting a PHP application framework call to a remote server, the call part of a distributed transaction that occurs over multiple servers including at least one PHP application;
setting a business transaction name associated with the call;
modifying PHP framework call with the business transaction name; and
transmitting the modified PHP framework call to the remote server.

11. The non-transitory computer readable medium of claim 10, further comprising:
detecting framework loading;
setting a business transaction name based on the loaded framework; and
setting a business transaction type based on the loaded framework.

12. The non-transitory computer readable medium of claim 10, wherein the PHP framework call is detected before a framework is loaded, the method further comprising:
setting business transaction name based on an network address associated with the call; and
setting a business transaction type to a default value.

13. The non-transitory computer readable medium of claim 10, further comprising modifying the PHP framework call to include a unique request identifier.

14. The non-transitory computer readable medium of claim 10, further comprising:
retrieving call data by an agent; and
transmitting the call data by the agent.

15. The non-transitory computer readable medium of claim 10, further comprising transmitting a business transaction type, the business transaction name, and a call chain including a sequence of calls for the business transaction to a controller.

16. The non-transitory computer readable medium of claim 15, wherein the remote server receives the modified PHP framework call and reports processing of the call to the controller.

17. The non-transitory computer readable medium of claim 16, wherein the remote server includes a JAVA application which

18. The non-transitory computer readable medium of claim 16, wherein the remote server includes a .NET application.

19. A system for tracing a distributed transaction, comprising:
a processor;
memory;
one or more modules stored in the memory and executable by the processor to detect a PHP application framework call to a remote server, the call part of a distributed transaction that occurs over multiple servers including at least one PHP application, set a business transaction name associated with the call, modify PHP framework call with the business transaction name, and transmit the modified PHP framework call to the remote server.

20. The system of claim 19, the one or more modules further executable to:
detect framework loading;
set a business transaction name based on the loaded framework; and
set a business transaction type based on the loaded framework.

21. The system of claim 19, wherein the PHP framework call is detected before a framework is loaded, the one or more modules further executable to:
setting business transaction name based on an network address associated with the call; and
setting a business transaction type to a default value.

22. The system of claim 19, the one or more modules further executable to modify the PHP framework call to include a unique request identifier.

23. The system of claim 19, the one or more modules further executable to:
retrieving call data by an agent; and
transmitting the call data by the agent.

24. The system of claim 19, the one or more modules further executable to transmit a business transaction type, the business transaction name, and a call chain including a sequence of calls for the business transaction to a controller.

25. The system of claim 24, wherein the remote server receives the modified PHP framework call and reports processing of the call to the controller.

26. The system of claim 25, wherein the remote server includes a JAVA application which

27. The system of claim 25, wherein the remote server includes a .NET application.
